(19) United States
(12) Patent Application Publication
(10) Pub. No.: US 2023/0134394 A1
(43) Pub. Date: May 4, 2023

(54) TERMINAL DEVICE, WIRELESS COMMUNICATION SYSTEM, AND RETRANSMISSION CONTROL METHOD

(71) Applicant: FUJITSU LIMITED, Kawasaki-shi (JP)

(72) Inventors: Yuki TERASHIMA, Yokohama (JP); Jianming Wu, Kawasaki (JP); Huiting Cheng, yokohama (JP)

(73) Assignee: FUJITSU LIMITED, Kawasaki-shi (JP)

(21) Appl. No.: 18/087,143

(22) Filed: Dec. 22, 2022

Related U.S. Application Data
(63) Continuation of application No. PCT/JP2020/029903, filed on Aug. 4, 2020.

(51) Int. Cl. H04L 1/18; H04W 72/20; H04W 72/566

(52) U.S. Cl. CPC H04L 1/18; H04W 72/20; H04W 72/566

(57) ABSTRACT

A terminal device includes wireless communication processor circuitry that transmits and receives signals to and from a first terminal device and a second terminal device, and a controller that detects an occurrence of simultaneous transmission by the first terminal device and the second terminal device on the basis of control information including information that identifies a wireless resource used as the data channel, the control information being received by the wireless communication processor circuitry and transmitted from the first terminal device and the second terminal device by use of a control channel, wherein the wireless communication processor circuitry transmits the signals to at least any one of the first terminal device and the second terminal device through a feedback channel, in a case the simultaneous transmission is detected.

### CROSS-REFERENCE TO RELATED APPLICATION(S)

This application is a continuation application of International Application PCT/JP2020/029903, filed on Aug. 4, 2020, and designating the U.S., the entire contents of which are incorporated herein by reference.

### FIELD

The embodiments discussed herein are related to terminal devices, wireless communication systems, and retransmission control methods.

### BACKGROUND

Traffic of mobile terminals (such as smartphones and feature phones) occupies the majority of resources of existing networks. The traffic of mobile terminals is apt to increase evermore.

There is also a demand for keeping pace with services having various requirements, in accordance with development of Internet of Things (IoT) services (for example, transportation systems, smart meters, and monitoring systems for devices). Therefore, for communication standards of Fifth Generation Mobile Communication (5G or New Radio (NR)), there is a demand for, in addition to the standard technology for Fourth Generation Mobile Communication (4G), technology for implementing further increase of data rates and capacities and further reduction of delays.

For Fifth Generation Communication Standards, technical reviews by working groups (for example, TSG-RAN WG1 and TSG-RAN WG2) of Third Generation Partnership Project (3GPP) are underway and written standards have been updated since December, 2017 (Non-Patent Literature 2 to Non-Patent Literature 28).

To keep pace with various services as mentioned above, for 5G, supporting many use cases has been supposed, the use cases being classified as Enhanced Mobile Broad Band (eMBB), Massive Machine Type Communications (MTC), and Ultra-Reliable and Low Latency Communication (URLLC).

Furthermore, the 3GPP working groups are also discussing New Radio Vehicle to Everything (NR-V2X) Communication. NR-V2X is a generic term for, for example, Vehicle to Vehicle (V2V) where communication between vehicles is performed using a sidelink channel, Vehicle to Pedestrian (V2P) where communication is performed between a vehicle and a pedestrian, Vehicle to Infrastructure (V2I) where communication is performed between a vehicle and road infrastructure, such as a road sign, and Vehicle to Network (V2N) where communication is performed between a vehicle and a network. The specification related to V2X is described in 3GPP TS 22.186 V16.2.0 (2019-06), for example.

Methods of allocating resources in NR-V2X communication include a method where a control channel (a physical sidelink control channel: PSCCH) and a data channel (a physical sidelink shared channel: PSSCH) are subjected to time division multiplexing (TDM) or frequency division multiplexing (FDM). To a PSCCH resource, sidelink control information (SCI) including, for example, information related to the modulation scheme and code rate for data in the corresponding PSSCH is mapped.

Furthermore, to improve the channel quality of sidelinks, feedback channels (physical sidelink feedback channels: PSFCHs) have been introduced. A PSFCH is used in controlling retransmission of data. That is, transmitting, by using a PSFCH, from a terminal device at a receiving end, information indicating whether or not retransmission of data is needed enables control of retransmission by a terminal device at a transmitting end. For example, in a case where group casting is performed, the following two types of retransmission control using a PSFCH are available, the group casting being where data are transmitted from a terminal device to plural terminal devices belonging to the same group.

In the first type of retransmission control, each of the terminal devices in the group transmits a negative acknowledgement (NACK) indicating that retransmission of data is needed, through a PSFCH, in a case where that terminal device has not received the corresponding data correctly even though it has received control information, for example, SCI. Furthermore, in a case where the terminal device has received the control information and data correctly, it does not send anything through the PSFCH. Therefore, in a case where the other terminal device that has transmitted that data receives the NACK through the PSFCH, it retransmits the data.

In the second type of retransmission control, each of the terminal devices in the group transmits a NACK through the PSFCH, similarly to the first type of retransmission control described above, in a case where that terminal device has not received the corresponding data correctly even though it has received control information. Furthermore, in a case where the terminal device has received the control information and data correctly, it transmit an acknowledgement (ACK) indicating that retransmission of the data is not needed, through the PSFCH. Therefore, in a case where the other terminal device that has transmitted the data does not receive the ACK through the PSFCH, that is, in a case where it receives the NACK or does not receive anything, it retransmits the data.
Patent Literature 1: International Publication Pamphlet No. WO 2015/115505
Non-Patent Literature 1: 3GPP TS 22.186 V16.2.0 (2019-06)
Non-Patent Literature 2: 3GPP TS 37.340 V16.2.0 (2020-07)
Non-Patent Literature 3: 3GPP TS 38.201 V16.0.0 (2019-12)
Non-Patent Literature 4: 3GPP TS 38.202 V16.1.0 (2020-06)
Non-Patent Literature 5: 3GPP TS 38.211 V16.2.0 (2020-06)
Non-Patent Literature 6: 3GPP TS 38.212 V16.2.0 (2020-06)
Non-Patent Literature 7: 3GPP TS 38.213 V16.2.0 (2020-06)
Non-Patent Literature 8: 3GPP TS 38.214 V16.2.0 (2020-06)
Non-Patent Literature 9: 3GPP TS 38.215 V16.2.0 (2020-06)
Non-Patent Literature 10: 3GPP TS 38.300 V16.2.0 (2020-07)
Non-Patent Literature 11: 3GPP TS 38.321 V16.1.0 (2020-07)
Non-Patent Literature 12: 3GPP TS 38.322 V16.1.0 (2020-07)
Non-Patent Literature 13: 3GPP TS 38.323 V16.1.0 (2020-07)
Non-Patent Literature 14: 3GPP TS 38.331 V16.1.0 (2020-07)
Non-Patent Literature 15: 3GPP TS 38.401 V16.2.0 (2020-07)
Non-Patent Literature 16: 3GPP TS 38.410 V16.2.0 (2020-07)
Non-Patent Literature 17: 3GPP TS 38.413 V16.2.0 (2020-07)
Non-Patent Literature 18: 3GPP TS 38.420 V16.0.0 (2020-07)
Non-Patent Literature 19: 3GPP TS 38.423 V16.2.0 (2020-07)
Non-Patent Literature 20: 3GPP TS 38.470 V16.2.0 (2020-07)
Non-Patent Literature 21: 3GPP TS 38.473 V16.2.0 (2020-07)
Non-Patent Literature 22: 3GPP TR 38.801 V14.0.0 (2017-03)
Non-Patent Literature 23: 3GPP TR 38.802 V14.2.0 (2017-09)
Non-Patent Literature 24: 3GPP TR 38.803 V14.2.0 (2017-09)
Non-Patent Literature 25: 3GPP TR 38.804 V14.0.0 (2017-03)
Non-Patent Literature 26: 3GPP TR 38.900 V15.0.0 (2018-06)
Non-Patent Literature 27: 3GPP TR 38.912 V16.0.0 (2020-07)
Non-Patent Literature 28: 3GPP TR 38.913 V16.0.0 (2020-07)

A terminal device that implements V2X communication may sometimes perform half-duplex communication where transmission and reception are not executed simultaneously for cost reduction, for example. When performing transmission, a terminal device that performs half-duplex communication does not receive control information and data transmitted from another terminal device.

Therefore, in a case where plural terminal devices in the same group perform transmission simultaneously, for example, control information and data transmitted from another terminal device in the group are not received by the plural terminal devices that are performing transmission. That is, when the terminal devices that perform transmission simultaneously are performing the transmission, they do not detect transmission of the control information and data from that other terminal device. As a result, these terminal devices transmit no ACKs and NACKs through PSFCHs.

However, because no ACKs and NACKs are transmitted, a wireless communication system where the above described first type of retransmission control is performed has a problem of not implementing appropriate retransmission and thus having less communication reliability. Specifically, in a case where terminal devices perform half-duplex communication in a wireless communication system where the first type of retransmission control is implemented, even though some terminal devices in the group have not received data correctly, the data may be not retransmitted. That is, since the terminal device that was performing transmission can not detect control information and data transmitted from another terminal device and does not transmit either ACK or NACK. In a case where the first type of retransmission control is implemented, retransmission of the data thus does not occur. As a result, reliability demanded for the wireless communication system may be not met. For example, a high reliability of 99.99% to 99.999% is demanded for a wireless communication system for autonomous driving, but in a case where the terminal devices implement half-duplex communication, appropriate data retransmission is not performed, and meeting the demanded reliability becomes difficult.

### SUMMARY

According to an aspect of an embodiment, a terminal device includes a wireless communication unit that transmits and receives signals to and from a first terminal device and a second terminal device, and a control unit that detects an occurrence of simultaneous transmission by the first terminal device and the second terminal device on the basis of control information including information that identifies a wireless resource used as the data channel, the control information being received by the wireless communication unit and transmitted from the first terminal device and the second terminal device by use of a control channel, wherein the wireless communication unit transmits the signals to at least any one of the first terminal device and the second terminal device through a feedback channel, in a case the simultaneous transmission is detected.

The object and advantages of the disclosure will be realized and attained by means of the elements and combinations particularly pointed out in the claims.

It is to be understood that both the foregoing general description and the following detailed description are exemplary and explanatory and are not restrictive of the disclosure, as claimed.

### BRIEF DESCRIPTION OF DRAWINGS

FIG. 1 is a diagram illustrating a configuration of a wireless communication system according to a first embodiment;

FIG. 2 is a block diagram illustrating a configuration of a terminal device according to the first embodiment;

FIG. 3 is a flow diagram illustrating a retransmission control method according to the first embodiment;

FIG. 4 is a diagram illustrating a specific example of timing of transmission and reception by terminal devices;

FIG. 5 is a diagram for comparison between specific examples of reception rates;

FIG. 6 is a block diagram illustrating a configuration of a terminal device according to a second embodiment;

FIG. 7 is a flow diagram illustrating a retransmission control method according to the second embodiment; and

FIG. 8 is a diagram illustrating a specific example of timing of transmission and reception by terminal devices.

### DESCRIPTION OF EMBODIMENTS

Preferred embodiments of the present disclosure will be explained with reference to accompanying drawings. The present disclosure is not to be limited by these embodiments.

### [A] First Embodiment

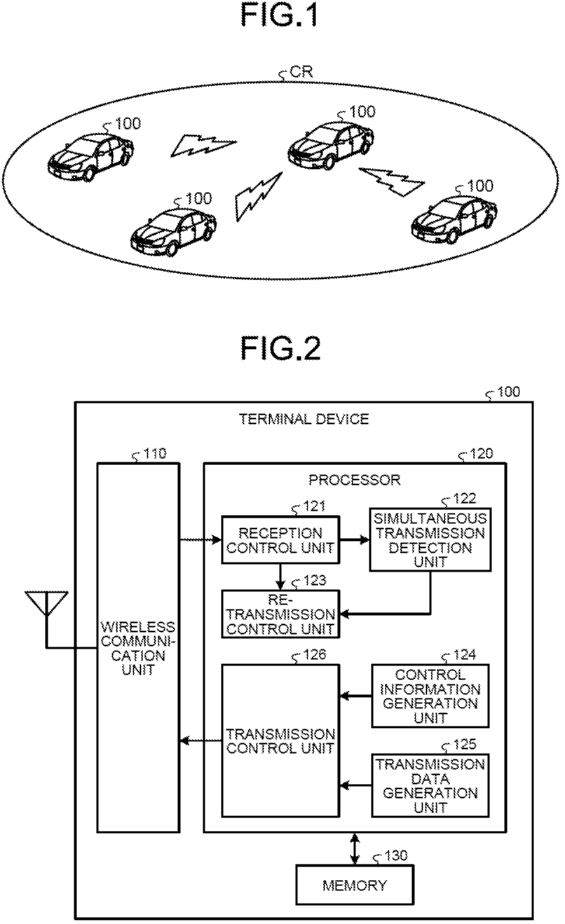

FIG. 1 is a diagram illustrating a configuration of a wireless communication system according to a first embodiment. As illustrated in FIG. 1, each of plural terminal devices 100 mounted in vehicles, for example, forms a group with the other terminal devices 100 positioned within a communication range (CR) from that terminal device 100, and executes group casting in the group. That is, each of the terminal devices 100 transmits a signal to the other terminal devices 100 in its communication range CR and receives signals from the other terminal devices 100 in the communication range CR.

However, each of the terminal devices 100 executes transmission and reception of signals by half-duplex communication and thus does not receive any signal from the other terminal devices 100 when that terminal device 100 is performing transmission and does not transmit any signal to the other terminal devices 100 when the terminal device 100 is performing reception. Furthermore, each of the terminal devices 100 executes retransmission control, such as a hybrid automatic repeat request (HARQ), for example. That is, in a case where the terminal device 100 has not received corresponding data correctly even though it has received control information, for example, SCI, the terminal device 100 requests retransmission of the data. Specifically, in a case where the terminal device 100 has not received the data correctly, the terminal device 100 transmits a NACK indicating that retransmission of the data is needed, through a PSFCH.

Furthermore, in a case where the terminal device 100 has detected, on the basis of control information, for example, SCI, that the plurality of terminal devices 100 in the group transmit sets of data simultaneously, the terminal device 100 transmits a NACK through PSFCHs even if the terminal device 100 receives the sets of data correctly. That is, in a case where the plural terminal devices 100 in the group are performing transmission simultaneously, the terminal device 100 transmits the NACK on behalf of these terminal devices 100.

FIG. 2 is a block diagram illustrating a configuration of one of the terminal devices 100 according to the first embodiment. The terminal device 100 illustrated in FIG. 2 has a wireless communication unit 110, a processor 120, and a memory 130.

The wireless communication unit 110 executes wireless communication with the other terminal devices 100. That is, the wireless communication unit 110 performs predetermined wireless transmission processing of a transmission signal output from the processor 120 to transmit the transmission signal to the other terminal devices 100 via an antenna. Furthermore, the wireless communication unit 110 receives signals from the other terminal devices 100 via the antenna, performs predetermined wireless reception processing of the signals received to output the received signals to the processor 120.

The processor 120 includes, for example, a central processing unit (CPU), a field programmable gate array (FPGA), or a digital signal processor (DSP), and integrally controls the whole terminal device 100. Specifically, the processor 120 has a reception control unit 121, a simultaneous transmission detection unit 122, a retransmission control unit 123, a control information generation unit 124, a transmission data generation unit 125, and a transmission control unit 126.

The reception control unit 121 demodulates and decodes a signal received by the wireless communication unit 110, obtains control information, such as SCI, through a control channel, such as a PSCCH, for example, and obtains data through a data channel, such as a PSSCH, for example. In this process, on the basis of a result of decoding of the control information, such as the SCI, the reception control unit 121 identifies a wireless resource used as the data channel, and executes demodulation and decoding for the data channel.

On the basis of a result of decoding for the control channel, the simultaneous transmission detection unit 122 detects that some of the terminal devices 100 in the group are executing transmission simultaneously. Specifically, the simultaneous transmission detection unit 122 obtains information that identifies a wireless resource used as a data channel, from control information, and determines whether or not data channels of the plurality of terminal devices 100 overlap in time. In a case where the data channels of the plurality of terminal devices 100 overlap in time, the simultaneous transmission detection unit 122 detects occurrence of simultaneous transmission by these terminal devices 100.

In a case where a correct result of decoding of data has not been obtained by the reception control unit 121, the retransmission control unit 123 generates a NACK indicating that retransmission of the data is needed, and outputs the NACK to the transmission control unit 126. That is, in a case where accuracy of decoding for a data channel at the reception control unit 121 does not meet a predetermined standard, the retransmission control unit 123 generates a retransmission request to the terminal device 100 that has transmitted the data.

Furthermore, in a case where occurrence of simultaneous transmission by the plurality of terminal devices 100 has been detected by the simultaneous transmission detection unit 122, the retransmission control unit 123 generates a NACK indicating that retransmission of sets of data is needed, and outputs the NACK to the transmission control unit 126. That is, in a case where temporal overlap of data channels of the plurality of terminal devices 100 has been detected, the retransmission control unit 123 generates a retransmission request to these terminal devices 100.

Furthermore, after control information and transmission data have been transmitted by the transmission control unit 126, the retransmission control unit 123 monitors a feedback channel corresponding to the transmission data, and in a case where a NACK is received through the feedback channel, the retransmission control unit 123 performs retransmission control for the transmission data that have been transmitted. That is, in a case where the NACK is received, the retransmission control unit 123 instructs the transmission control unit 126 to retransmit the transmission data that have been transmitted.

The control information generation unit 124 generates control information related to data transmitted to the other terminal devices 100. Specifically, the control information generation unit 124 generates SCI including information identifying a wireless resource used as a data channel, for example.

The transmission data generation unit 125 generates data to be transmitted to the other terminal devices 100.

The transmission control unit 126 transmits control information and transmission data through physical channels, such as a PSCCH and a PSSCH, for example. That is, the transmission control unit 126 transmits the control information through a control channel, such as a PSCCH, for example, and transmits the transmission data through a data channel, such as a PSSCH, for example.

Furthermore, the transmission control unit 126 transmits a NACK generated by the retransmission control unit 123 through a feedback channel corresponding to a data channel. That is, in a case where decoding for the data channel has failed and the NACK has been generated, the transmission control unit 126 transmits the NACK through the feedback channel corresponding to the data channel for which the decoding failed. Furthermore, in a case where simultaneous transmission by the plurality of terminal devices 100 has been detected and the NACK has been generated, the transmission control unit 126 transmits the NACK through the feedback channels corresponding to the data channels overlapping in time.

Furthermore, the transmission control unit 126 retransmits transmission data that have been transmitted, according to an instruction from the retransmission control unit 123.

The memory 130 includes, for example, a random access memory (RAM) or a read only memory (ROM) and stores therein information used in processing by the processor 120.

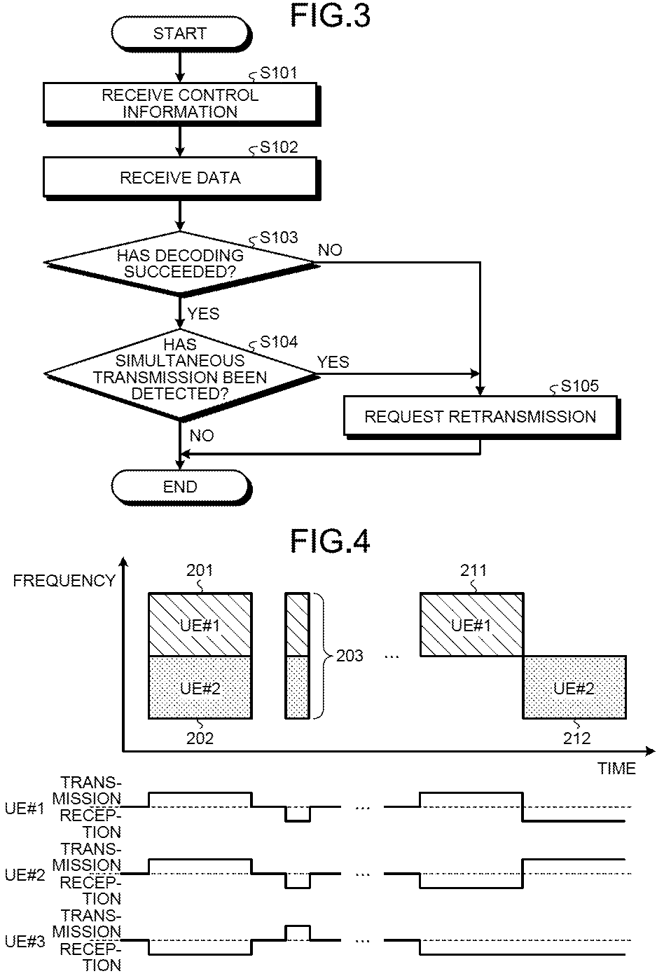

A retransmission control method implemented by the terminal devices 100 configured as described above will be described next while reference is made to a flow diagram illustrated in FIG. 3.

Group casting is performed in a group to which a terminal device 100 belongs and another terminal device 100 in that group transmits control information and data. Specifically, the control information is transmitted through a control channel, such as a PSCCH, for example, and the data are transmitted through a data channel, such as a PSSCH, for example.

In response to reception of a signal through the control channel by the wireless communication unit 110 (Step S101), demodulation and decoding for the control channel are executed by the reception control unit 121 and the control information is thereby obtained. The control information includes information identifying a wireless resource used as the data channel, and a signal through the data channel is thus received by use of this information (Step S102) and demodulation and decoding for the data channel are executed by the reception control unit 121.

Whether or not the decoding for the data channel has succeeded is determined by the retransmission control unit 123 (Step S103), and in a case where it is determined by the retransmission control unit 123 that the decoding for the data channel has failed and retransmission of the data is needed (Step S103: No), a NACK to request the retransmission of the data is generated by the retransmission control unit 123. The NACK generated is transmitted by the transmission control unit 126 using a feedback channel corresponding to the data channel for which the decoding has failed. In other words, retransmission of the data that have not been received correctly is requested (Step S105).

On the contrary, in a case where the decoding for the data channel has succeeded (Step S103: Yes), whether or not plural terminal devices 100 have executed transmission simultaneously is determined by the simultaneous transmission detection unit 122 (Step S104). Specifically, information identifying wireless resources used as data channels is obtained from control information, and a determination on whether or not the data channels of the plural terminal devices 100 overlap in time is made. As a result of the determination, in a case where the data channels do not overlap in time, there is no simultaneous transmission by plural terminal devices 100 (Step S104: No), and the processing is thus ended without transmission of a retransmission request.

As a result of the determination at Step S104, in a case where the data channels overlap in time, simultaneous transmission by plural terminal devices 100 is thus detected (Step S104: Yes), and a NACK to request retransmission of sets of data transmitted simultaneously is generated by the retransmission control unit 123. The NACK generated is transmitted by the transmission control unit 126 using feedback channels corresponding to the data channels overlapping in time. In other words, retransmission of the sets of data transmitted simultaneously by the plural terminal devices 100 is requested (Step S105).

As described above, in a case where plural ones of terminal devices 100 in a group transmit simultaneously, the terminal devices 100 that does not transmit simultaneously detects the simultaneous transmission based on the control information and requests retransmission of sets of data that have been transmitted simultaneously. Therefore, even if the terminal devices 100 that perform the simultaneous transmission do not request retransmission even though the terminal devices 100 do not receive the data because they are performing transmission, the other terminal device 100 that has received the sets of data will request retransmission instead. As a result, the sets of data that have been transmitted simultaneously are retransmitted, and the terminal devices 100 that have performed the simultaneous transmission can receive the set of data retransmitted at different timings from the other terminal devices 100. Therefore, even in a case where the terminal devices 100 perform half-duplex communication, appropriate retransmission of data is performed and reliability of the communication is able to be improved.

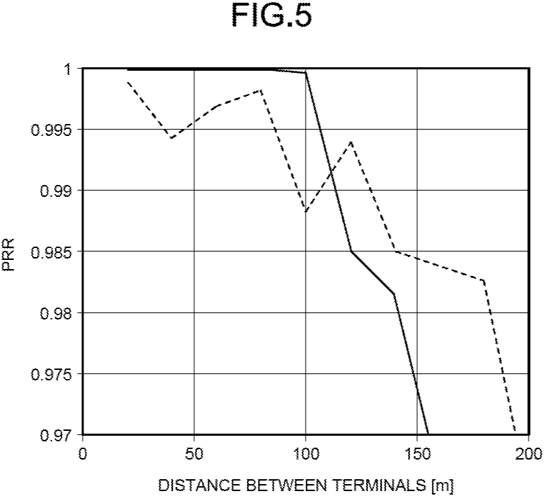

A specific example of retransmission control will be described next, while reference is made to FIG. 4. FIG. 4 is a diagram illustrating a specific example of timing of transmission and reception by terminal devices UE#1 to UE#3. These terminal devices UE#1 to UE#3 belong to the same group and perform transmission and reception of signals by group casting.

As illustrated in FIG. 4, the terminal devices UE#1 and UE#2 respectively transmit sets of data 201 and 202 by using wireless resources overlapping with each other in time. That is, the terminal devices UE#1 and UE#2 execute transmission simultaneously. Therefore, the terminal device UE#1 does not detect the transmission of the set of data 202 from the terminal device UE#2 and the terminal device UE#2 does not detect the transmission of the set of data 201 from the terminal device UE#1.

By contrast, the terminal device UE#3 that does not execute transmission at that time receives the sets of data 201 and 202 from the terminal devices UE#1 and UE#2. Furthermore, based on control information from the terminal devices UE#1 and UE#2, the terminal device UE#3 detects the simultaneous transmission of the sets of data 201 and 202. Accordingly, the terminal device UE#3 transmits a NACK 203 through feedback channels corresponding to the sets of data 201 and 202. That is, on behalf of the terminal devices UE#1 and UE#2 that do not request retransmission even though they do not receive the set of data 201 or 202 correctly, the terminal device UE#3 requests retransmission of the sets of data 201 and 202.

Because the terminal devices UE#1 and UE#2 respectively monitor the feedback channels corresponding to the sets of data 201 and 202, they receive the NACK 203 through these feedback channels. The terminal devices UE#1 and UE#2 then execute retransmission of the sets of data 201 and 202 by using reserved wireless resources for retransmission. Specifically, the terminal device UE#1 transmits a set of retransmitted data 211 and the terminal device UE#2 transmits a set of retransmitted data 212.

At this time, since the terminal devices UE#1 and UE#2 perform the retransmission at different timings, the set of retransmitted data 211 is received by the terminal devices UE#2 and UE#3 that are not transmitting. Similarly, the set of retransmitted data 212 is received by the terminal devices UE#1 and UE#3 that are transmitting. Thus, the terminal devices UE#1 and UE#2 that have not received the set of data 202 or 201 from each other are able to receive the set of retransmitted data 212 or 211 respectively. As described above, since the terminal device UE#3 requesting retransmission on behalf of the terminal devices UE#1 and UE#2, the terminal devices UE#1 and UE#2 can receive the set of retransmitted data 212 or 211 transmitted from each other. Then the reliability of the communication can be improved.

FIG. 5 is a diagram illustrating a specific example of relations between distance between terminal devices and packet reception ratio (PRR) indicating reliability of communication. In FIG. 5, it is assumed that the communication range is 100 meters and each of terminal devices does not request retransmission of data transmitted from any terminal device outside the communication range. A solid line in FIG. 5 represents the PRR in a case where retransmission is requested for sets of data transmitted simultaneously, and a broken line in FIG. 5 represents the PRR in a case where retransmission is not requested for sets of data transmitted simultaneously.

As observed from FIG. 5, among the terminal devices within the communication range of 100 meters, the PRR can be maintained at a high level of 99.9% or more if the other terminal device that receives both of sets of data simultaneously transmitted sends retransmission request of these sets of data to the plurality of terminal devices. On the other hand, in a case where no retransmission request if made for the sets of data transmitted simultaneously, even between the terminal devices within the communication range of 100 meters, the PRR is decreased to about 98.8%. In this way, the reliability of communication can be improved by making retransmission requests for data that are simultaneously transmitted.

As described above, according to this embodiment, in a case where the plurality of terminal devices in a group transmit sets of data simultaneously, the other terminal devices that receives these sets of data executes a retransmission request for the sets of data simultaneously transmitted. Therefore, the terminal devices that transmit the sets of data simultaneously are able to respectively receive the sets of transmitted data and reliability of the communication is thus able to be improved.

### [B] Second Embodiment

A second embodiment is characterized in that when the reserved wireless resources for retransmission of simultaneously transmitted sets of data overlap in time, a request for retransmission is made to any one of these terminal devices to prevent the transmission of sets of data from being simultaneous transmitted.

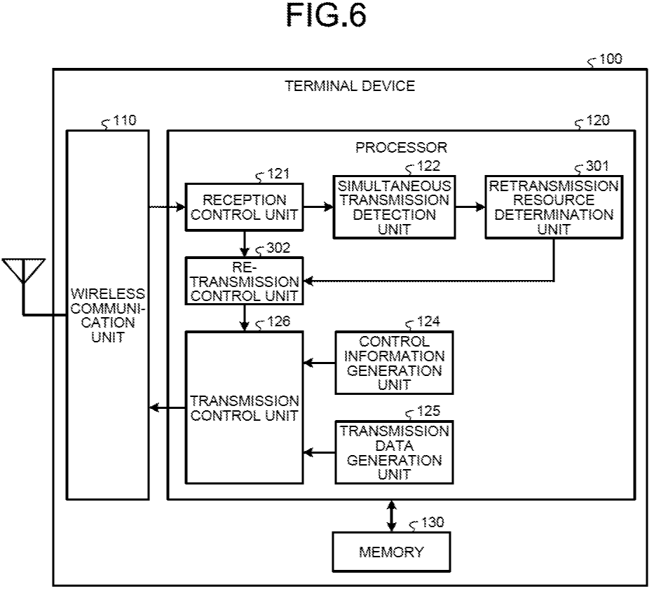

FIG. 6 is a block diagram illustrating a configuration of a terminal device 100 according to a second embodiment. In FIG. 6, the same reference signs are assigned to components that are the same as those in FIG. 2 and description thereof will be omitted. The terminal device 100 illustrated in FIG. 6 has a retransmission resource determination unit 301 and a retransmission control unit 302, instead of the retransmission control unit 123 in the terminal device 100 illustrated in FIG. 2.

In a case where occurrence of simultaneous transmission by plural terminal devices 100 has been detected by a simultaneous transmission detection unit 122, the retransmission resource determination unit 301 determines whether or not wireless resources for retransmission of sets of data simultaneously transmitted overlap with each other in time. That is, the retransmission resource determination unit 301 obtains information identifying the wireless resources used in the retransmission of the sets of data, from control information, and makes a determination on whether or not the wireless resources for the retransmission corresponding to the plural sets of data simultaneously transmitted overlap in time. The retransmission resource determination unit 301 notifies the retransmission control unit 302 of a result of the determination.

In a case where a correct result of decoding of a set of data has not been obtained by a reception control unit 121, the retransmission control unit 302 generates a NACK indicating that retransmission of the set of data is needed, and outputs the NACK to a transmission control unit 126. That is, in a case where accuracy of decoding for a data channel at the reception control unit 121 does not satisfy a predetermined standard, the retransmission control unit 302 generates a retransmission request to the terminal device 100 that has transmitted the set of data.

Furthermore, according to a result of the determination by the retransmission resource determination unit 301, the retransmission control unit 302 generates a NACK indicating that retransmission of sets of data is needed and outputs the NACK to the transmission control unit 126. Specifically, in a case where occurrence of simultaneous transmission by plural terminal devices 100 has been detected and wireless resources for retransmission of sets of data simultaneously transmitted do no overlap in time, the retransmission control unit 302 generates a NACK related to all of the sets of data transmitted simultaneously. In a case where occurrence of simultaneous transmission by plural terminal devices 100 has been detected and wireless resources for retransmission of sets of data simultaneously transmitted overlap in time, the retransmission control unit 302 compares priorities of the sets of data transmitted simultaneously. The retransmission control unit 302 then generates a NACK related to the set of data having the highest priority, of the sets of data for which the wireless resources for retransmission temporally in time.

In a case where wireless resources for retransmission of sets of data are each provided at plurality of timings, the retransmission control unit 302 may generate NACKs respectively related to the sets of data so that the wireless resources for retransmission of the sets of data transmitted simultaneously do not overlap with each other in time. That is, in a case where two terminal devices 100 that simultaneous transmitted data reserve wireless resources for retransmission that overlapp with each other twice in time, a transmission request may be made so that the sets of data are retransmitted from the two terminal devices 100 by using separate wireless resources for retransmission. That is, the retransmission control unit 302 may send retransmission request to the terminal device 100 that have a higher priority so that a set of data is retransmitted from the terminal devices 100 by using separate wireless resources.

Furthermore, after control information and transmission data have been transmitted by the transmission control unit 126, the retransmission control unit 302 monitors a feedback channel corresponding to the transmission data, and in a case where a NACK is received through the feedback channel, the retransmission control unit 302 performs retransmission control for the transmission data that have been transmitted. That is, in a case where the NACK has been received, the retransmission control unit 302 instructs the transmission control unit 126 to retransmit the transmission data that have been transmitted.

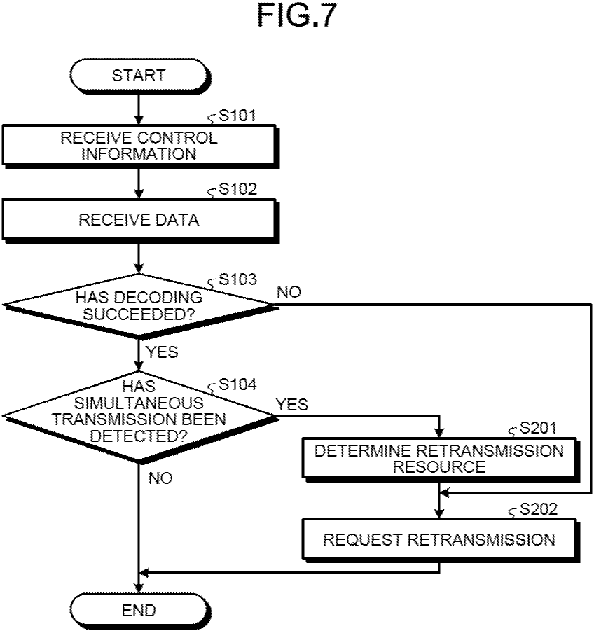

A retransmission control method implemented by the terminal device 100 configured as described above will be described next while reference is made to a flow diagram illustrated in FIG. 7. In FIG. 7, the same reference signs are assigned to steps that are the same as those in FIG. 3 and detailed description thereof will be omitted.

In response to reception of a signal through a control channel by a wireless communication unit 110 (Step S101), demodulation and decoding for the control channel are executed by the reception control unit 121 and control information is thereby obtained. The control information includes information identifying a wireless resource used as a data channel, a signal through the data channel is thus received by use of this information (Step S102), and demodulation and decoding for the data channel are executed by the reception control unit 121.

Whether or not the decoding for the data channel has succeeded is determined by the retransmission control unit 302 (Step S103), and in a case where it is determined by the retransmission control unit 302 that the decoding for the data channel has failed and retransmission of data is needed (Step S103: No), a NACK to request retransmission of the data is generated by the retransmission control unit 302. The NACK generated is transmitted by the transmission control unit 126 using a feedback channel corresponding to the data channel for which the decoding has failed. In other words, a request for retransmission of the data that have not been received correctly is made (Step S202).

On the contrary, in a case where the decoding for the data channel has succeeded (Step S103: Yes), a determination on whether or not plural terminal devices 100 have executed transmission simultaneously is made by the simultaneous transmission detection unit 122 (Step S104). As a result of this determination, in a case where there is no simultaneous transmission by plural terminal devices 100 (Step S104: No), the processing is ended without transmission of a retransmission request.

When simultaneous transmission by a plurality of terminal devices 100 is detected as a result of the determination at Step S104 (Step S104: Yes), the retransmission resource determination unit 301 determines whether or not wireless resources for retransmission of simultaneously transmitted sets of data overlap in time (Step S201). Specifically, because information identifying the wireless resources used in retransmission of the sets of data is included in control information, the information identifying the wireless resources for retransmission of the sets of data transmitted simultaneously is obtained by the retransmission resource determination unit 301 and a determination on whether or not the wireless resources for retransmission overlap in time is made by the retransmission resource determination unit 301.

As a result of the determination, in a case where the wireless resources for retransmission do not overlap in time, a NACK to request retransmission of the sets of data transmitted simultaneously is generated by the retransmission control unit 302. The NACK generated is transmitted by the transmission control unit 126 using feedback channels corresponding to the data channels overlapping in time. In other words, retransmission of the sets of data transmitted simultaneously by the plural terminal devices 100 is requested (Step S202).

In a case where the wireless resources for retransmission overlap in time, priorities of the sets of data transmitted simultaneously are compared to each other by the retransmission control unit 302. Comparison between the priorities may be comparison between priorities of the sets of data based on information on Quality of Service (QoS) included in the control information, or comparison between priorities of the terminal devices 100 that have transmitted the sets of data. A NACK related to the set of data having the highest priority, of the sets of data for which the wireless resources for retransmission overlap in time, is then generated. The NACK generated is transmitted by the transmission control unit 126 using a feedback channel corresponding to the set of data having the highest priority. In other words, retransmission of the set of data having the highest priority, of the sets of data transmitted simultaneously by the plural terminal devices 100, is requested (Step S202).

For any set of data other than the set of data having the highest priority, of the sets of data for which the reserved wireless resources for retransmission overlap in time, a NACK may be transmitted by use of a feedback channel at a later time. That is, in a case where wireless resources for retransmission at plural timings are reserved for one set of data, the timing at which the NACK is fed back may be shifted so that sets of data that have been transmitted simultaneously using wireless resources for retransmission at different timings may be retransmitted.

As described above, in a case where the plurality of terminal devices 100 in a group perform simultaneous transmission, the other terminal devices 100 detects the simultaneous transmission on the basis of control information and then determines whether or not wireless resources for retransmission of sets of data transmitted simultaneously overlap each other temporally. In a case where the wireless resources for retransmission overlap in time, retransmission is requested so that the set of data having a higher priority of the sets of data transmitted simultaneously is preferentially retransmitted. Therefore, in a case where sets of data are simultaneously transmitted from plural terminal devices 100, retransmission of these sets of data is prevented from being done simultaneously and the sets of data retransmitted are able to be received infallibly.

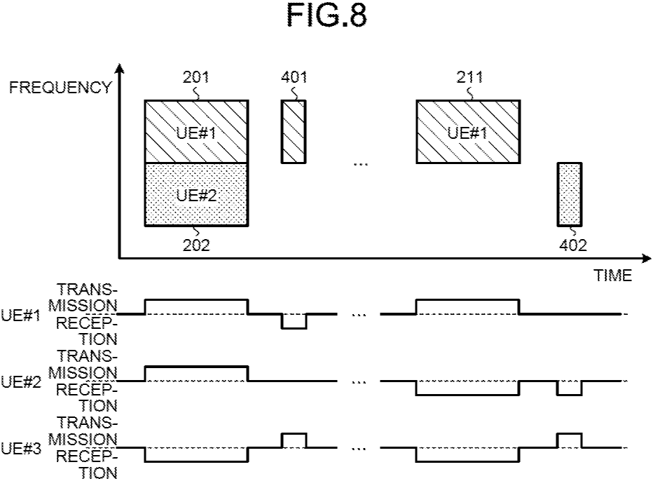

A specific example of retransmission control will be described next, while reference is made to FIG. 8. FIG. 8 is a diagram illustrating a specific example of timing of transmission and reception by terminal devices UE#1 to UE#3. In FIG. 8, the same references signs are assigned to portions that are the same as those in FIG. 4. The terminal devices UE#1 to UE#3 illustrated in FIG. 8 belong to the same group and transmit and receive signals by group casting.

As illustrated in FIG. 8, the terminal devices UE#1 and UE#2 respectively transmit sets of data 201 and 202 by using wireless resources overlapping in time. That is, the terminal devices UE#1 and UE#2 execute transmission simultaneously. Therefore, the terminal device UE#1 does not detect the transmission of the set of data 202 from the terminal device UE#2 and the terminal device UE#2 does not detect the transmission of the set of data 201 from the terminal device UE#1.

By contrast, the terminal device UE#3 that does not execute transmission at that time receives the sets of data 201 and 202 from the terminal devices UE#1 and UE#2. Furthermore, on the basis of control information from the terminal devices UE#1 and UE#2, the terminal device UE#3 detects the simultaneous transmission of the sets of data 201 and 202. The terminal device UE#3 then identifies, from the control information, wireless resources for retransmission of the sets of data 201 and 202, and makes a determination on whether or not the wireless resources for retransmission overlap in time. It is assumed herein the wireless resources for retransmission overlap with each other and the set of data 201 of the sets of data 201 and 202 has a higher priority. Therefore, the terminal device UE#3 transmits a NACK 401 through a feedback channel corresponding to the set of data 201. That is, the terminal device UE#3 makes a retransmission request related to the set of data 201 having the higher priority of the sets of data 201 and 202 transmitted simultaneously.

Because the terminal devices UE#1 and UE#2 respectively monitor the feedback channels corresponding to the sets of data 201 and 202, the terminal device UE#1 receives the NACK 401 through the feedback channel corresponding to the set of data 201. The terminal device UE#2, on the other hand, does not receive a NACK through the feedback channel corresponding to the set of data 202. Therefore, by using the predetermined wireless resource for retransmission, the terminal device UE#1 executes retransmission for the set of data 201. Specifically, the terminal device UE#1 transmits a set of retransmitted data 211.

Even though predetermined times at which the terminal devices UE#1 and UE#2 perform retransmission overlap each other, only the terminal device UE#1 transmits the set of retransmitted data 211, and the set of retransmitted data 211 is thus received by the terminal devices UE#2 and UE#3 that are not executing any transmission. The terminal device UE#2 that has not received the set of data 201 is thereby able to receive the set of retransmitted data 211. As described above, the terminal device UE#3 requesting retransmission of the set of data 201 having a higher priority, of the sets of data 201 and 202 that are transmitted simultaneously and are predetermined to be retransmitted at the same time, enables the terminal device UE#2 to receive the set of retransmitted data 211 for the set of data 201 having the higher priority and thus enables reliability of the communication to be improved.

In a case where the wireless resource for retransmission has been reserved at plural timings for each of the sets of data 201 and 202, the terminal device UE#3 transmits the NACK 401 through a feedback channel corresponding to the wireless resource for the first retransmission, so that the set of data 201 is retransmitted by use of this wireless resource. The terminal device UE#3 may then transmit a NACK 402 through a feedback channel corresponding to the wireless resource for the second retransmission so that the set of data 202 is retransmitted by use of this wireless resource. As a result, even in the case where the wireless resources for retransmission of the sets of data 201 and 202 transmitted simultaneously overlap each other temporally, both of the sets of data 201 and 202 are able to be retransmitted by use of wireless resources at different timings.

As described above, according to this embodiment, in a case where the plurality of terminal devices in a group simultaneously transmit sets of data, the other terminal devices that receives these sets of data determines whether or not wireless resources for retransmission of the sets of data simultaneously transmitted overlap in time. In a case where the wireless resources for retransmission overlap in time, a retransmission request for the set of data having a higher priority is preferentially executed. Therefore, even in the case where the wireless resources for retransmission of the sets of data simultaneously transmitted overlap each other, the set of data having the higher priority is retransmitted at a time different from that for the other set of data. As a result, the terminal devices that transmit the sets of data simultaneously are able to receive a set of retransmitted data having the higher priority and reliability of the communication is able to be improved.

According to one aspect of a terminal device, a wireless communication system, and a retransmission control method disclosed by this application, reliability of communication can be improved.

All examples and conditional language recited herein are intended for pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although the embodiments of the present disclosure have been described in detail, it should be understood that the various changes, substitutions, and alterations could be made hereto without departing from the spirit and scope of the disclosure.

What is claimed is:

1. A terminal device, comprising:
wireless communication processor circuitry that transmits and receives signals to and from a first terminal device and a second terminal device; and
a controller that detects an occurrence of simultaneous transmission by the first terminal device and the second terminal device on the basis of control information including information that identifies a wireless resource used as the data channel, the control information being received by the wireless communication processor circuitry and transmitted from the first terminal device and the second terminal device by use of a control channel, wherein
the wireless communication processor circuitry transmits the signals to at least any one of the first terminal device and the second terminal device through a feedback channel, in a case the simultaneous transmission is detected.

2. The terminal device according to claim 1, wherein
the controller generates retransmission request to at least any one of the first terminal device and the second terminal device, in a case the controller detects the simultaneous transmission, and
the wireless communication processor circuitry transmits the signals including the retransmission request through the feedback channel.

3. The terminal device according to claim 1, wherein in the controller detects the occurrence of simultaneous transmission by determining, on the basis of the control information, whether or not the data channels corresponding to the first terminal device and the second terminal device overlap with each other.

4. The terminal device according to claim 1, wherein feedback channels are feedback channels corresponding to the first terminal device and the second terminal device.

5. The terminal device according to claim 1, wherein
the controller determines, in a case where the simultaneous transmission is detected, whether or not wireless resources used by the first terminal device and the second terminal device overlap with each other, and
the wireless communication processor circuitry transmits, in a case where the wireless resources have been determined to overlap each other, the signals only to any one of the first terminal device and the second terminal device through the feedback channel.

6. The terminal device according to claim 5, wherein the wireless communication processor circuitry transmits, in a case where the wireless resources have been determined to overlap with each other, one of sets of data transmitted from the first terminal device and the second terminal device, the one having a higher priority through the feedback channel.

7. The terminal device according to claim 1, wherein the wireless communication processor circuitry performs half-duplex communication where transmission and reception of signals are not executed simultaneously.

8. The terminal device according to claim 1, wherein the feedback channel is used in case retransmission is requested.

9. A wireless communication system, comprising:
a first terminal device that transmits a signal;
a second terminal device that transmits a signal simultaneously with the first terminal device; and
a third terminal device that receives the signals from the first terminal device and the second terminal device, wherein
the third terminal device includes:
wireless communication processor circuitry that transmits and receives signals to and from the first terminal device and the second terminal device; and
a processor connected to the wireless communication processor circuitry, wherein
the processor executes:
detecting, on the basis of a signal received by the wireless communication processor circuitry, occurrence of simultaneous transmission by the first terminal device and the second terminal device,
generating a retransmission request to at least any one of the first terminal device and the second terminal device, in a case where the processor has detected the simultaneous transmission, and
causing the generated retransmission request to be transmitted from the wireless communication processor circuitry,
any one of the first terminal device and the second terminal device executes retransmission of the signal, in a case where that one of the first terminal device and the second terminal device has received the retransmission request transmitted from the third terminal device, and
the other one of the first terminal device and the second terminal device receives the signal retransmitted from that one of the first terminal device and the second terminal device.

10. A retransmission control method executed by a terminal device that receives signals from a first terminal device and a second terminal device, the retransmission control method comprising:
detecting, on the basis of the signals received, occurrence of simultaneous transmission by the first terminal device and the second terminal device;
generating a retransmission request to at least any one of the first terminal device and the second terminal device, in a case where the simultaneous transmission has been detected, and
transmitting the retransmission request generated.
